(19) United States
(12) Patent Application Publication
(10) Pub. No.: US 2014/0320294 A1
(43) Pub. Date: Oct. 30, 2014

(54) FIRE FIGHTING GUIDING SYSTEM

(71) Applicant: HON HAI PRECISION INDUSTRY CO., LTD., New Taipei (TW)

(72) Inventors: SHIH-CHENG WANG, New Taipei (TW); YI-WEN CAI, New Taipei (TW)

(73) Assignee: HON HAI PRECISION INDUSTRY CO., LTD., New Taipei (TW)

(21) Appl. No.: 14/060,544

(22) Filed: Oct. 22, 2013

(30) Foreign Application Priority Data
Apr. 25, 2013 (TW) 102114907

(51) Int. Cl. G08B 5/36; G08B 17/00

(52) U.S. Cl. CPC G08B 5/36; G08B 17/00
USPC 340/628

(57) ABSTRACT

A fire fighting guiding system is employed in a building where there is at least one fire extinguisher. The fire fighting guiding system includes a fire detecting module, a storage module, a communication module and at least one projection module corresponding to the at least one fire extinguisher. The fire detecting module detects if there is a fire in the building and sends a fire signal when there is a fire. The first storage module stores images respectively related to each of the at least one fire extinguisher. The communication module transmits the images according to the fire signal. Each projection module receives the image related to the fire extinguisher corresponding to the projection module and project the received image on a wall adjacent to the fire extinguisher.

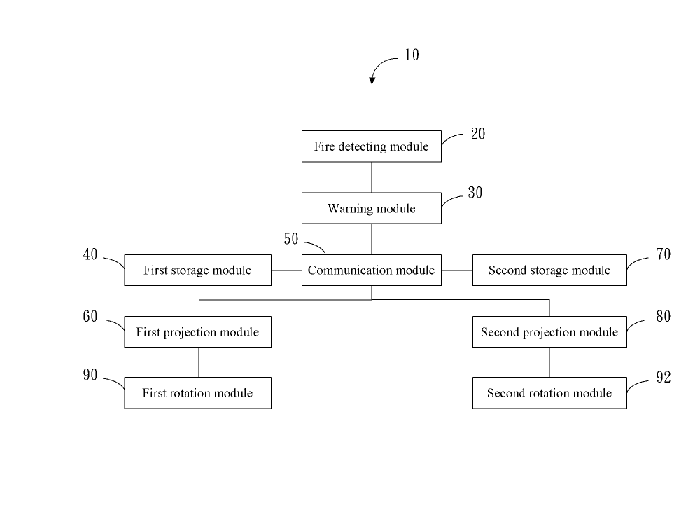

### BACKGROUND

1. Technical Field

The present disclosure relates to a fire fighting guiding system.

2. Description of Related Art

Fire extinguishers are installed in buildings to fight fires. The fire extinguishers are generally installed at inconspicuous areas. When there is a fire, the fire extinguisher needs to be found quickly.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

The drawing is a block diagram of a fire fighting guiding system.

### DETAILED DESCRIPTION

The drawing shows a fire fighting guiding system 10 according to an exemplary embodiment is provided. The fire fighting guiding system 10 is employed in a building where there is at least one fire extinguisher. The fire guiding system 10 includes a fire detecting module 20, an warning module 30, a first storage module 40, a communication module 50 and at least one first projection module 60 corresponding to the at least one fire extinguisher.

The fire detecting module 20 is configured to detect whether there is a fire in the building and send a fire signal to the warning module 30 and the communication module 50 when there is a fire. The warning module 30 is configured to sound an alarm to warn people there is a fire. The first storage module 40 is configured to store images respectively related to each of the at least one fire extinguisher. In the illustrated embodiment, the images indicate how to use the at least one fire extinguisher. The communication module 50 is configured to transmit the image related to the fire device to the first projection module 60 corresponding to the fire device according to the fire signal. The first projection module 60 is configured to receive the image and project the image on a wall of the building adjacent to the fire extinguisher associated with the received image to help the people to find and use the fire extinguisher. In the exemplary embodiment, the fire detecting module 20 is a smoke detector.

In an alternative exemplary embodiment, the fire fighting guiding system 10 further includes a second storage module 70 and at least one second projection module 80 installed in at least one hallway in the building. The second storage module 70 is configured to store exits respectively corresponding to each hallway. Each exit includes an evacuation direction and an evacuation path.

The communicating module 50 is further configured to transmit the exits corresponding to the hallway to the second projection module 60 installed in the hallway according to the fire signal.

The second projection module 60 is configured to project an image of an exit corresponding to the hallway on a wall of the building corresponding to the hallway to help the people to quickly exit.

In another illustrated embodiment, the fire fighting guiding system 10 further includes at least one first rotation module 90 connected to the at least one first projection module 60. The at least one first rotation module 90 is configured to drive the at least one first projection module 60 to rotate to make the image related to the fire extinguisher reciprocally move toward and away from the fire device. In the illustrated embodiment, the first rotation module 90 includes a stepper motor. The stepper motor is connected to the first projection module 60 by a rotation shaft. The stepper motor drives the rotation shaft to rotate the first projection module 60.

In another illustrated embodiment, the fire fighting guiding system 10 further includes at least one second rotation module 92 connected to the at least one second projection module 80. The at least one second rotation module 90 is configured to rotate the at least one second projection module 80 to make the image of the exit reciprocally move along the exit direction. In the exemplary embodiment, the rotation module 92 includes a stepper motor. The stepper motor is connected to the second projection module 80 by a rotation shaft. The stepper motor drives the rotation shaft to rotate to drive the second projection module 80 rotate.

It is to be understood, however, that even though numerous characteristics and advantages of the present disclosure have been set fourth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A fire fighting guiding system employed in a building where there are a plurality of fire extinguishers, the fire fighting guiding system comprising:
a fire detecting module configured to detect whether there is a fire in the building and send a fire signal when there is a fire;
a first storage module configured to store a plurality of images each associated with at least one of the fire extinguishers;
a communication module configured to transmit the image according to the fire signal;
a plurality of first projection modules each arranged spatially corresponding to the at least one of the fire extinguishers and configured to receive the image from the communication module and project the received image on a wall of the building adjacent to the at least one of the fire extinguishers associated with the received image.

2. The fire guiding system as described in claim 1, further comprising a first rotation module connected to each first projection module, the first rotation module configured to drive the first projection module to rotate to make the image move toward and away from the at least one of the fire extinguishers.

3. The fire guiding system as described in claim 1, wherein the fire detecting module is a smoke detector.

4. The fire guiding system as described in claim 1, further comprising a warning module, the warning module configured to sound an alarm to warn people there is the fire in response to the fire signal.

5. The fire guiding system as described in claim 1, wherein the images are configured to display how to use the corresponding fire extinguishers.

6. The fire guiding system as described in claim 1, further comprising a second storage module and at least one second projection module installed in at least one hallway of the building, the second storage module configured to store images of exits of the corresponding hallway, the communication module further configured to transmit image of an evacuation path of the corresponding hallway to the second projection module, the second projection module configured to project the image of the exits on a wall of the hallway.

7. The system as described in claim 6, wherein the image shows an evacuation direction and an evacuation path.

8. The system as described in claim 7, further comprising at least one second rotation module connected to the at least one second projection module, the at least one second rotation module configured to drive the at least one second projection module to rotate to make the image reciprocally move along the evacuation direction.
